(19) United States
(12) Patent Application Publication
(10) Pub. No.: US 2024/0015692 A1
(43) Pub. Date: Jan. 11, 2024

(54) ROBUST INDOOR POSITIONING SYSTEMS

(71) Applicant: Samsung Electronics Co., Ltd., Suwon-si (KR)

(72) Inventors: Hossein Najaf-Zadeh, Allen, TX (US); Jae Son, Plano, TX (US); Mark Trayer, Allen, TX (US); Djordje Preradovic, Oakland, MI (US); Gabriel Montenegro, Bradenton, FL (US); José Korneluk, Lake Worth, FL (US)

(21) Appl. No.: 18/345,761

(22) Filed: Jun. 30, 2023

Related U.S. Application Data
(60) Provisional application No. 63/358,421, filed on Jul. 5, 2022.

(51) Int. Cl. H04W 64/00; H04W 4/33

(52) U.S. Cl. CPC H04W 64/006; H04W 4/33

(57) ABSTRACT

A method for robust indoor positioning systems includes receiving, from each of a plurality of anchors, a signal based on which a tag distance corresponding to a distance of a tag from the respective anchor is identified, and determining a plurality of anchor sets from the plurality of anchors. The method further includes, for each of the anchor sets, determining, based on the tag distances corresponding to anchors in the anchor set, a preliminary tag location corresponding to the respective anchor set; and determining a final tag location based on the preliminary tag locations.

### CROSS-REFERENCE TO RELATED APPLICATION(S) AND CLAIM OF PRIORITY

This application claims priority under 35 U.S.C. § 119(e) to U.S. Provisional Patent Application No. 63/358,421 filed on Jul. 5, 2022. The above-identified provisional patent application is hereby incorporated by reference in its entirety.

### TECHNICAL FIELD

This present disclosure relates generally to wireless communications systems and, more specifically, the present disclosure relates to methods and apparatuses for robust indoor positioning systems.

### BACKGROUND

Location based services are increasingly being used to locate target objects such as other people, warehouse inventory, equipment, and the like. Accurate positioning of target objects is an essential part of location-based services. In outdoor environments, accurate positioning can be performed using a global positioning systems (GPS). However, outdoor positioning systems may fail in indoor environments due to the lack of (or a very weak) GPS signal. For indoor positioning, a wireless positioning system such as Ultra-Wideband (UWB) positioning is desirable due to accurate distance measurement and low energy consumption. On the other hand, the performance of a wireless positioning system is degraded in cluttered environments with scattered objects that block the direct view between a wireless transmitter (i.e., tag) and receiver (i.e., anchor). Thus, methods may be used to provide robust and accurate positioning.

### SUMMARY

This disclosure provides methods and apparatuses for robust indoor positioning systems.

In one embodiment, an apparatus is provided. The apparatus includes a transceiver configured to receive, from each of a plurality of anchors, a signal based on which a tag distance corresponding to a distance of a tag from the respective anchor is identified. The apparatus further includes a processor operably coupled to the transceiver, configured to determine a plurality of anchor sets from the plurality of anchors, for each of the anchor sets, determine, based on the tag distances corresponding to anchors in the anchor set, a preliminary tag location corresponding to the respective anchor set, and determine a final tag location based on the preliminary tag locations.

In another embodiment, a method is provided. The method includes receiving, from each of a plurality of anchors, a signal based on which a tag distance corresponding to a distance of a tag from the respective anchor is identified, and determining a plurality of anchor sets from the plurality of anchors. The method further includes, for each of the anchor sets, determining, based on the tag distances corresponding to anchors in the anchor set, a preliminary tag location corresponding to the respective anchor set, and determining a final tag location based on the preliminary tag locations.

In yet another embodiment, a non-transitory computer readable medium embodying a computer program is provided. The computer program comprises computer readable program code that when executed causes at least one processing device to receive, from each of a plurality of anchors, a signal based on which a tag distance corresponding to a distance of a tag from the respective anchor is identified, and determine a plurality of anchor sets from the plurality of anchors. The computer program comprises computer readable program code that when executed causes at least one processing device to, for each of the anchor sets, determine, based on the tag distances corresponding to anchors in the anchor set, a preliminary tag location corresponding to the respective anchor set, and determine a final tag location based on the preliminary tag locations.

In another embodiment, a method is provided. The method includes determining a first anchor position for an anchor location that covers a largest portion of a workspace, identifying a remaining portion of the workspace is uncovered by the first anchor position, determining an additional anchor position for an additional anchor location that covers a largest part of the remaining portion of the workspace, and determining whether a portion of the remaining portion of the workspace uncovered by the additional anchor position is below a threshold.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system in accordance with an embodiment of this disclosure;

FIG. 2 illustrates an example electronic device in accordance with an embodiment of this disclosure;

FIG. 3 illustrates an example system in which wireless positioning anchor locations can be determined for service areas of an indoor location based service according to embodiments of the present disclosure;

FIG. 4 illustrates an example system in which wireless positioning anchor locations can be determined for service areas of an indoor location based service according to embodiments of the present disclosure;

FIG. 5 illustrates an example special arrangement of a system in which wireless positioning anchor locations can be determined for service areas of an indoor location based service according to embodiments of the present disclosure;

FIG. 6 illustrates an example illustrates an example special arrangement of a system in which wireless positioning anchor locations can be determined for service areas of an indoor location based service according to embodiments of the present disclosure;

FIG. 7 illustrates an example method of tag location determination according to embodiments of the present disclosure;

FIG. 8 illustrates an example method of tag location determination 800 according to embodiments of the present disclosure;

FIG. 9 illustrates an example method of tag location determination 900 according to embodiments of the present disclosure;

FIG. 10 illustrates an example illustrates an example special arrangement of a system in which UWB anchor locations can be determined for service areas of an indoor location based service according to embodiments of the present disclosure;

FIG. 11 illustrates an example method of tag location determination according to embodiments of the present disclosure;

FIG. 12 illustrates an example method of tag location determination utilizing both BLE and UWB according to embodiments of the present disclosure;

FIG. 13 illustrates an example method of tag location determination utilizing both WiFi-RTT and UWB according to embodiments of the present disclosure;

FIG. 14 illustrates an example method of tag location determination utilizing both photogrammetry and UWB according to embodiments of the present disclosure;

FIG. 15 illustrates an example method of tag location determination utilizing both an application and UWB according to embodiments of the present disclosure;

FIG. 16 illustrates an example method of tag location determination utilizing both a service area boundary and UWB according to embodiments of the present disclosure; and

FIG. 17 illustrates an example method of anchor placement utilizing according to embodiments of the present disclosure.

### DETAILED DESCRIPTION

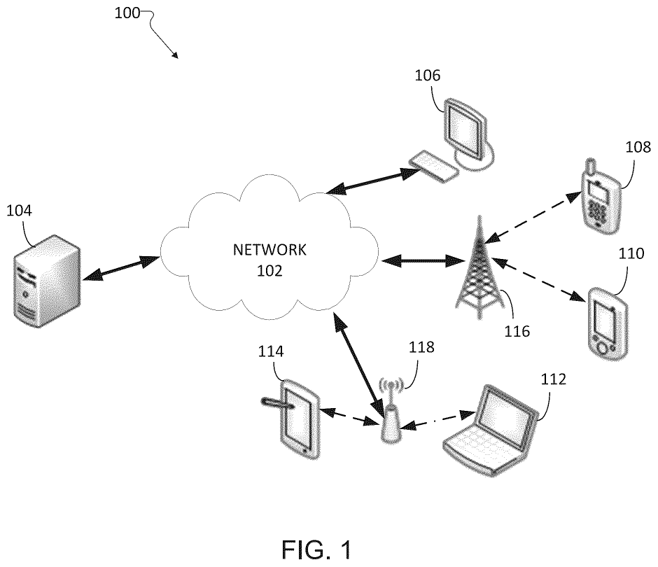

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone (such as a UE), a tablet computer, a laptop, a personal computer, a wearable device, a head mounted display, or the like. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102.

Each of the client devices 106-114 represent any suitable computing or processing device that interacts with at least one server (such as the server 104) or other computing device(s) over the network 102. The client devices 106-114 include a desktop computer 106, a mobile telephone or mobile device 108 (such as a smartphone), a PDA 110, a laptop computer 112, and a tablet computer 114. However, any other or additional client devices could be used in the communication system 100, such as wearable devices. Smartphones represent a class of mobile devices 108 that are handheld devices with mobile operating systems and integrated mobile broadband cellular network connections for voice, short message service (SMS), and Internet data communications. In certain embodiments, any of the client devices 106-114 can perform processes for determining UWB beacon locations for service areas for a location based service.

In this example, some client devices 108-114 communicate indirectly with the network 102. For example, the mobile device 108 and PDA 110 communicate via one or more base stations 116, such as cellular base stations or eNodeBs (eNBs) or gNodeBs (gNBs). Also, the laptop computer 112 and the tablet computer 114 communicate via one or more wireless access points 118, such as IEEE 802.11 wireless access points. Note that these are for illustration only and that each of the client devices 106-114 could communicate directly with the network 102 or indirectly with the network 102 via any suitable intermediate device(s) or network(s). In certain embodiments, any of the client devices 106-114 transmit information securely and efficiently to another device, such as, for example, the server 104.

As described in more detail below, one or more of the network 102, server 104, and client devices 106-114 include circuitry, programing, or a combination thereof, to support methods for robust indoor positioning systems.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

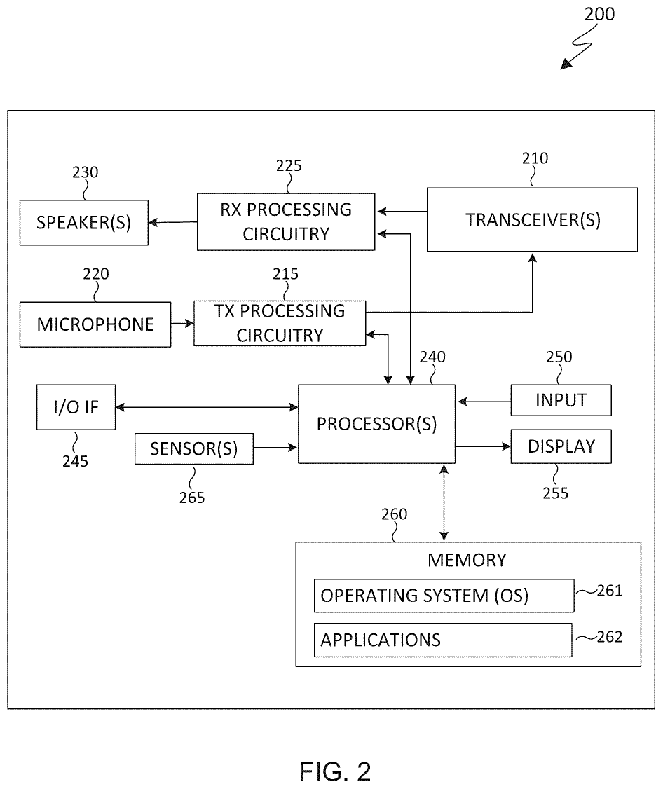

FIG. 2 illustrates an example electronic device in accordance with an embodiment of this disclosure. In particular, FIG. 2 illustrates an example electronic device 200, and the electronic device 200 could represent the server 104 or one or more of the client devices 106-114 in FIG. 1. The electronic device 200 can be a mobile communication device, such as, for example, a UE, a mobile station, a subscriber station, a wireless terminal, a desktop computer (similar to the desktop computer 106 of FIG. 1), a portable electronic device (similar to the mobile device 108, the PDA 110, the laptop computer 112, or the tablet computer 114 of FIG. 1), a robot, and the like.

As shown in FIG. 2, the electronic device 200 includes transceiver(s) 210, transmit (TX) processing circuitry 215, a microphone 220, and receive (RX) processing circuitry 225. The transceiver(s) 210 can include, for example, a RF transceiver, a BLUETOOTH transceiver, a WiFi transceiver, a ZIGBEE transceiver, an infrared transceiver, and various other wireless communication signals. The electronic device 200 also includes a speaker 230, a processor 240, an input/output (I/O) interface (IF) 245, an input 250, a display 255, a memory 260, and a sensor 265. The memory 260 includes an operating system (OS) 261, and one or more applications 262.

The transceiver(s) 210 can include an antenna array including numerous antennas. For example, the transceiver(s) 210 can be equipped with multiple antenna elements. There can also be one or more antenna modules fitted on the terminal where each module can have one or more antenna elements. The antennas of the antenna array can include a radiating element composed of a conductive material or a conductive pattern formed in or on a substrate. The transceiver(s) 210 transmit and receive a signal or power to or from the electronic device 200. The transceiver(s) 210 receives an incoming signal transmitted from an access point (such as a base station, WiFi router, or BLUETOOTH device) or other device of the network 102 (such as a WiFi, BLUETOOTH, cellular, 5G, LTE, LTE-A, WiMAX, or any other type of wireless network). The transceiver(s) 210 down-converts the incoming RF signal to generate an intermediate frequency or baseband signal. The intermediate frequency or baseband signal is sent to the RX processing circuitry 225 that generates a processed baseband signal by filtering, decoding, and/or digitizing the baseband or intermediate frequency signal. The RX processing circuitry 225 transmits the processed baseband signal to the speaker 230 (such as for voice data) or to the processor 240 for further processing (such as for web browsing data).

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, and/or digitizes the outgoing baseband data to generate a processed baseband or intermediate frequency signal. The transceiver(s) 210 receives the outgoing processed baseband or intermediate frequency signal from the TX processing circuitry 215 and up-converts the baseband or intermediate frequency signal to a signal that is transmitted.

The processor 240 can include one or more processors or other processing devices. The processor 240 can execute instructions that are stored in the memory 260, such as the OS 261 in order to control the overall operation of the electronic device 200. For example, the processor 240 could control the reception of forward channel signals and the transmission of reverse channel signals by the transceiver(s) 210, the RX processing circuitry 225, and the TX processing circuitry 215 in accordance with well-known principles. The processor 240 can include any suitable number(s) and type(s) of processors or other devices in any suitable arrangement. For example, in certain embodiments, the processor 240 includes at least one microprocessor or microcontroller. Example types of processor 240 include microprocessors, microcontrollers, digital signal processors, field programmable gate arrays, application specific integrated circuits, and discrete circuitry. In certain embodiments, the processor 240 can include a neural network.

The processor 240 is also capable of executing other processes and programs resident in the memory 260, such as operations that receive and store data, and for example, processes that support methods for robust indoor positioning systems. The processor 240 can move data into or out of the memory 260 as required by an executing process. In certain embodiments, the processor 240 is configured to execute the one or more applications 262 based on the OS 261 or in response to signals received from external source(s) or an operator. For example, applications 262 can include a multimedia player (such as a music player or a video player), a phone calling application, a virtual personal assistant, and the like.

The processor 240 is also coupled to the I/O interface 245 that provides the electronic device 200 with the ability to connect to other devices, such as client devices 106-114. The I/O interface 245 is the communication path between these accessories and the processor 240.

The processor 240 is also coupled to the input 250 and the display 255. The operator of the electronic device 200 can use the input 250 to enter data or inputs into the electronic device 200. The input 250 can be a keyboard, touchscreen, mouse, track ball, voice input, or other device capable of acting as a user interface to allow a user to interact with the electronic device 200. For example, the input 250 can include voice recognition processing, thereby allowing a user to input a voice command. In another example, the input 250 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 250 can be associated with the sensor(s) 265, a camera, and the like, which provide additional inputs to the processor 240. The input 250 can also include a control circuit. In the capacitive scheme, the input 250 can recognize touch or proximity.

The display 255 can be a liquid crystal display (LCD), light-emitting diode (LED) display, organic LED (OLED), active matrix OLED (AMOLED), or other display capable of rendering text and/or graphics, such as from websites, videos, games, images, and the like. The display 255 can be a singular display screen or multiple display screens capable of creating a stereoscopic display. In certain embodiments, the display 255 is a heads-up display (HUD).

The memory 260 is coupled to the processor 240. Part of the memory 260 could include a RAM, and another part of the memory 260 could include a Flash memory or other ROM. The memory 260 can include persistent storage (not shown) that represents any structure(s) capable of storing and facilitating retrieval of information (such as data, program code, and/or other suitable information). The memory 260 can contain one or more components or devices supporting longer-term storage of data, such as a read only memory, hard drive, Flash memory, or optical disc.

The electronic device 200 further includes one or more sensors 265 that can meter a physical quantity or detect an activation state of the electronic device 200 and convert metered or detected information into an electrical signal. For example, the sensor 265 can include one or more buttons for touch input, a camera, a gesture sensor, optical sensors, cameras, one or more inertial measurement units (IMUs), such as a gyroscope or gyro sensor, and an accelerometer. The sensor 265 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 265 can further include control circuits for controlling any of the sensors included therein. Any of these sensor(s) 265 may be located within the electronic device 200 or within a secondary device operably connected to the electronic device 200.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more neural networks, and the like. Also, while FIG. 2 illustrates the electronic device 200 configured as a mobile telephone, tablet, or smartphone, the electronic device 200 can be configured to operate as other types of mobile or stationary devices.

As discussed above, location based services are increasingly being deployed at homes, businesses, and industrial complex environments. Such location based services depend on the ability to accurately locate target objects within an environment in order to complete their intended tasks efficiently. For example, an inventory management system may need to locate a particular item of inventory within a particular area of a warehouse. In order to accurately locate target objects, a location based service needs to accurately measure distances. One method of measuring distances for location based services employs Ultra-Wideband (UWB) positioning.

UWB-based localization systems typically include two groups of UWB sensors (or nodes). The first group of UWB sensors—referred to as anchors—are installed at fixed locations throughout the service area. The second set of one or more UWB sensors, referred to as tags, could be installed on or integrated into a target object whose location is to be determined with respect to the known locations of the anchors. To generate a unique reference about the localization of a tag, the system needs three or more anchors with known positions (i.e., trilateration).

Although the anchors could be placed at pre-determined (known) locations, often the 2D or 3D positions of these anchors is determined through a process known as anchor self-calibration, anchor self-localization, or anchor auto-positioning. Anchor self-localization allows the system to be flexible such that the anchors could be placed around the service area without any special restrictions. Furthermore, this flexibility allows the user to install additional anchors to the system to extend the service area.

In UWB ranging, the distance between two anchors can be obtained by passing specific message frames between the two anchors. One of the anchors, designated as the initiator, sends a message to the other anchor designated as the responder. The responder sends a response frame after a certain time, which the initiator receives and computes the round-trip time of the message. The distance between the two anchors can then be inferred from the round-trip time and the speed of the RF signal (taken as equal to the speed of light).

To generate a blueprint of a location based service's environment, the system needs to accurately determine the 2D or 3D positions of the anchors. Furthermore, the accurate determination of the anchor locations is needed for proper localization of the target in the system environment. Finally, the system should allow the user to extend the service area if and when needed, thus allowing easy addition of new anchors to the system and determining the positions of the new anchors based on the known positions of the existing anchors.

When there are no obstacles, such as walls, furniture, or other objects, between two ranging nodes, there is a direct path for the radio signal to travel from one node to the other, resulting in unambiguous determination of time of the received signal at the receiving node. This condition is called a Line-of-Sight (LoS) condition. Conversely, when there are obstacles between the two ranging nodes, the UWB signals get reflected off one or more surfaces, resulting in multiple paths for propagation of the signal. In such conditions, called Non-Line-of-Sight (NLoS), it becomes difficult to accurately determine the time of the received signal at the receiver, resulting in the loss in accuracy of ranging measurements. Moreover, the strength of the signal reduces as it travels from the transmitting node to the receiving node due to propagation path losses. The transmitter-to-receiver distance and the signal frequency are two major factors contributing to the propagation path loss.

Consequently, the accuracy of UWB ranging and the subsequent tag localization estimate are influenced by the received signal strength (measured by RSSI) and the LoS/NLoS conditions. Therefore, target localization can be adversely impacted if the anchors are not installed suitably (i.e., disregarding the conditions that could result in poor range measurements).

To address these and other issues, this disclosure provides methods for redundant distance measurements followed by the removal of outliers (erroneous values) to provide robust and accurate positioning of targets. Moreover, a greedy algorithm is disclosed for localization anchor placement to use minimum quantity of anchors while covering almost an entire indoor space.

Note that while some of the embodiments discussed below are described in the context of locating objects within an indoor environment, these are merely examples. It will be understood that the principles of this disclosure may be implemented in any number of other suitable contexts or systems, including other home or industrial automation systems.

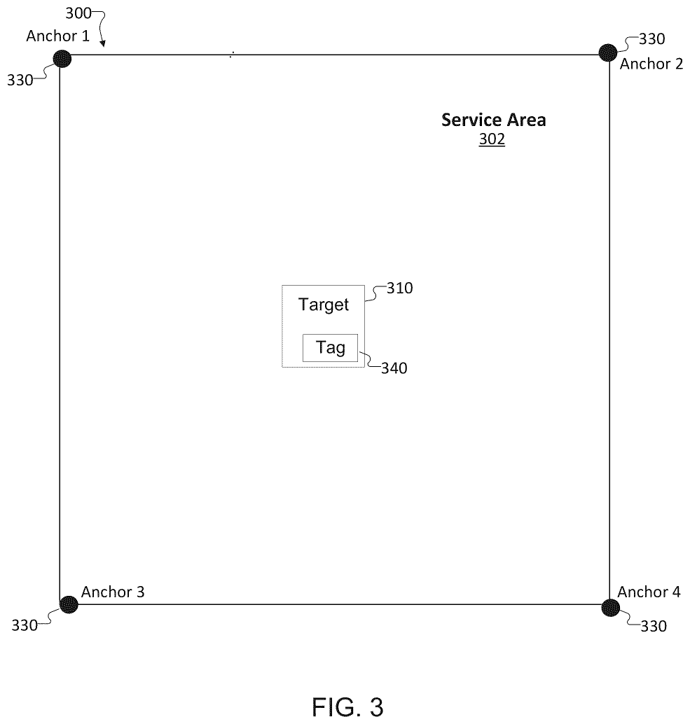

FIG. 3 illustrates an example system 300 in which wireless positioning anchor locations can be determined for service areas of an indoor location based service according to embodiments of the present disclosure. For ease of explanation, the system 300 will be described as including one or more components of the communication system 100 of FIG. 1, such as the client devices 106-114; however, the system 300 could be implemented using any other suitable device or system. The embodiment of the system 300 shown in FIG. 3 is for illustration only. Other embodiments of the system 300 could be used without departing from the scope of this disclosure.

As shown in FIG. 3, the system 300 includes a service area 302, a target object 310, and multiple anchors 330.

The service area 302 is a geographical area in which a location based service identifies target objects. In the system 300, the service area 302 represents an indoor space in which the target object 310 may be located.

The target object 310 is an object that can be located by a location based service of the service area 302 to the system 300. In some embodiments, the target object 310 is a personal consumer device, such as a smart phone or tablet. The target object 310 may represent (or be represented by) one of the client devices 106-114.

The anchors 330 include UWB sensors (or other types of RF sensors) and are placed in fixed locations throughout the service area 302 to provide reference for localization and for determining the service area 302. To generate unique reference about the localization, the system 300 may include three or more anchors 330, as described in greater detail below.

Target object 310 can include one or more tags 340. The tags 340 are wireless transmitters (for example UWB sensors) that are installed in (or otherwise connected to) the target object 310 and enable wireless communication with the anchors 330. In wireless based localization, the tags 340 are used to localize the target object 310 in the environment using the reference information provided by the anchors 330. In some embodiments, the target object 310 may not include a built-in tag 340 (such as when the target object 310 is a smart phone or tablet that is not configured for UWB or other communication used in wireless positioning systems).

The anchor 330 may include a UWB module (not shown) or other type of RF sensor that enables wireless communication with the target object 310. The anchor 330 may also include a secondary RF module that can be used to create a secondary wireless network for communication of data and commands between the anchors 330 and the tags 340. Consequently, the devices containing the tags 340 (e.g., the electronic device 310) also contain compatible RF modules. In one embodiment, the secondary RF modules are Bluetooth Low Energy (BLE) modules. Other embodiments may employ a secondary Wi-Fi network for the communication of data and commands between the anchors 330 and the tags 340.

Although FIG. 3 illustrates one example of a wireless positioning system, various changes may be made to FIG. 3. For example, a different quantity of anchors may be utilized, the target object may be an object other than an electronic device, etc.

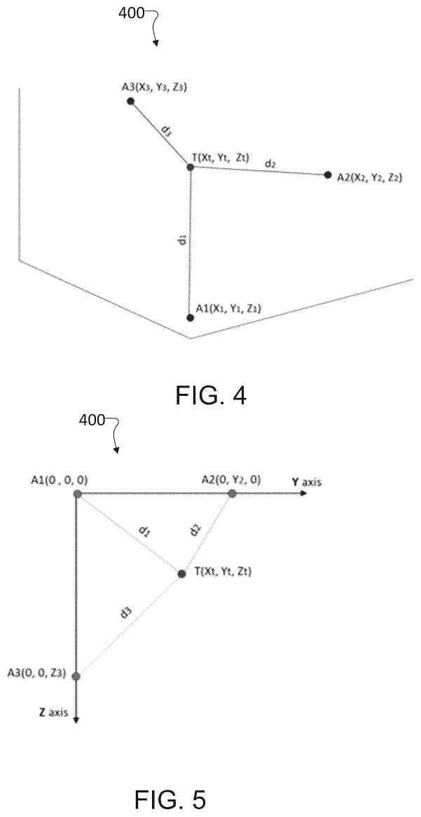

As previously described, to generate a unique reference about the localization of a tag, the system needs three or more anchors with known positions. An example method of localization of a tag utilizing three anchors is further described regarding FIG. 4.

FIG. 4 illustrates an example system 400 in which wireless positioning anchor locations can be determined for service areas of an indoor location based service according to embodiments of the present disclosure. The embodiment of the system 400 shown in FIG. 4 is for illustration only. Other embodiments of the system 400 could be used without departing from the scope of this disclosure.

In the example of FIG. 4, three wireless anchors A1, A2, and A3, located at (X₁, Y₁, Z₁), (X₂, Y₂, Z₂), (X₃, Y₃, Z₃) are used to locate a tag T (i.e., target). The distance of the tag from the anchors may be found as follows:

d₁²=(X₁−Xₜ)²+(Y₁−Yₜ)²+(Z₁−Zₜ)² (1)

d₂²=(X₂−Xₜ)²+(Y₂−Yₜ)²+(Z₂−Zₜ)² (2)

d₃²=(X₃−Xₜ)²+(Y₃−Yₜ)²+(Z₃−Zₜ)² (3)

Equations (1)-(3) can be solved to obtain the location of the tag. However, due to the quadratic form of the equations, there will be ambiguity in the location of the tag.

In order to overcome the positioning ambiguity, placement of the anchors in special locations may lead to significant simplification of equations (1)-(3), and significantly resolve positioning ambiguity. For example, the anchors may be placed as shown according to FIG. 5.

FIG. 5 illustrates a special arrangement of example system 400 in which wireless positioning anchor locations can be determined for service areas of an indoor location based service according to embodiments of the present disclosure.

In order to resolve ambiguity in the positioning of the tag, the anchors are placed at A1(0,0,0), A2(0,Y₂,0), and A3(0,0,Z₃). This specific anchor placement leads to simplified formulation for 3D positioning of the tag.

From equation 1 and 2, you have

$${d}_{1}^{2} = {d}_{2}^{2} - {Y}_{2}^{2} + 2 {Y}_{2} {Y}_{t}$$

$${Y}_{t} = \frac{{d}_{1}^{2} - {d}_{2}^{2} + {Y}_{2}^{2}}{2 {Y}_{2}}$$

and from equation 1 and 3, you have

$${d}_{1}^{2} = {d}_{3}^{2} - {Z}_{3}^{2} + 2 {Z}_{3} {Z}_{t}$$

$${Z}_{t} = \frac{{d}_{1}^{2} - {d}_{3}^{2} + {Z}_{3}^{2}}{2 {Z}_{3}}$$

and finally, from equation 1, you have

Xₜ²=d₁²−Yₜ²−Zₜ²

Xₜ=±\sqrt{d₁²−Yₜ²−Zₜ²}

There in an ambiguity in the sign of Xt. If it is assumed that the tag is restricted to move in one side of the YZ plane, then Xt will always have the same sign. As such, it can be assumed Xt>0 which resolves the ambiguity in the positioning of the tag.

Although FIGS. 4 and 5 illustrate one example of a wireless positioning system, various changes may be made to FIGS. 4 and 5. For example, the locations of the of anchors may differ, the target object may be a placed at a different location, etc.

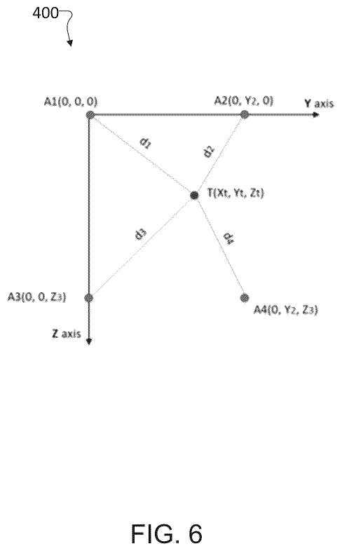

As described earlier, three anchors may locate a tag in 3D space. However, due to scattered objects and obstacles in indoor environments, the accuracy and stability of the wireless positioning may be significantly affected. To enhance the robustness of wireless positioning in cluttered indoor environments, one embodiment of the present disclosure uses more localization anchors followed by the removal of erroneous measurements. In one embodiment four anchors are used to find the 3D location of the tag. Four sets of three out of four anchors are selected to find the location of the tag and the final location is determined by averaging the locations found from the four sets of three anchors as described regarding FIG. 6.

FIG. 6 illustrates a special arrangement of example system 400 in which wireless positioning anchor locations can be determined for service areas of an indoor location based service according to embodiments of the present disclosure.

In the example of FIG. 6, anchors A1, A2, and A3 are positioned identically as illustrated in FIG. 6, and an additional anchor A4 is located at position (0, Y₂, Z₃). In this example, there are four sets of three out of four anchors: Anchor set (A3, A1, A2), anchor set (A1, A2, A4), anchor set (A2, A4, A3), and anchor set (A4, A3, A1).

The location of the tag using anchor set (A3, A1, A2) may be determined as follows:

$${Y}_{t 1} = \frac{{d}_{1}^{2} - {d}_{2}^{2} + {Y}_{2}^{2}}{2 {Y}_{2}}$$

$${Z}_{t 1} = \frac{{d}_{1}^{2} - {d}_{3}^{2} + {Z}_{3}^{2}}{2 {Z}_{3}}$$

$${X}_{t 1} = \sqrt{{d}_{1}^{2} - {Y}_{t 1}^{2} - {Z}_{t 1}^{2}}$$

The location of the tag using anchor set (A1, A2, A4) may be determined as follows:

$${Y}_{t 2} = {L}_{12} - \frac{{d}_{2}^{2} - {d}_{1}^{2} + {Y}_{2}^{2}}{2 {Y}_{2}}$$

$${Z}_{t 2} = \frac{{d}_{2}^{2} - {d}_{4}^{2} + {Z}_{3}^{2}}{2 {Z}_{3}}$$

$${X}_{t 2} = \sqrt{{d}_{1}^{2} - {Y}_{t 2}^{2} - {Z}_{t 2}^{2}}$$

where L₁₂ is the distance between A1 and A2.

The location of the tag using anchor set (A2, A4, A3) may be determined as follows:

$${Y}_{t 3} = {L}_{12} - \frac{{d}_{4}^{2} - {d}_{3}^{2} + {Y}_{2}^{2}}{2 {Y}_{2}}$$

$${Z}_{t 3} = {L}_{13} - \frac{{d}_{4}^{2} - {d}_{2}^{2} + {Z}_{3}^{2}}{2 {Z}_{3}}$$

$${X}_{t 3} = \sqrt{{d}_{1}^{2} - {Y}_{t 3}^{2} - {Z}_{t 3}^{2}}$$

where L₁₃ is the distance between A1 and A3.

The location of the tag using anchor set (A4, A3, A1) may be determined as follows:

$${Y}_{t 4} = \frac{{d}_{3}^{2} - {d}_{4}^{2} + {Y}_{2}^{2}}{2 {Y}_{2}}$$

$${Z}_{t 4} = {L}_{13} - \frac{{d}_{3}^{2} - {d}_{1}^{2} + {Z}_{3}^{2}}{2 {Z}_{3}}$$

$${X}_{t 4} = \sqrt{{d}_{1}^{2} - {Y}_{t 4}^{2} - {Z}_{t 4}^{2}}$$

The final 3D location of the tag may be determined via averaging of the locations found from the anchor sets as follows:

Xₜ=0.25 Σᵢ₌₁⁴Xₜᵢ

Yₜ=0.25 Σᵢ₌₁⁴Yₜᵢₗ

Zₜ=0.25 Σᵢ₌₁⁴Zₜᵢ

In another embodiment, any quantity of anchors greater than three may be used to localize the tag. For removing the erroneous values, instead of averaging, the median value of the 3D locations or other filters may be used to find the location of the tag.

For 2D positioning, the X coordinate (i.e., height) in the formulation described above may be ignored and the tag location will be located at (Yt, Zt).

Although FIG. 6 illustrates one example of a wireless positioning system, various changes may be made to 6. For example, the locations of the of anchors may differ, the quantity of anchors may differ, the target object may be a placed at a different location, etc.

As previously described, one embodiment of the present disclosure may use more localization anchors followed by the removal of erroneous measurements to improve the accuracy of tag location determinations. In some embodiments, groups of three anchors (out of N anchors) are used to find the location of the tag. Erroneous measurements are removed to make wireless positioning more accurate. The quantity of three-anchor sets may be given by:

$$numSets = \frac{N !}{3 ! ( N - 3 ) !}$$

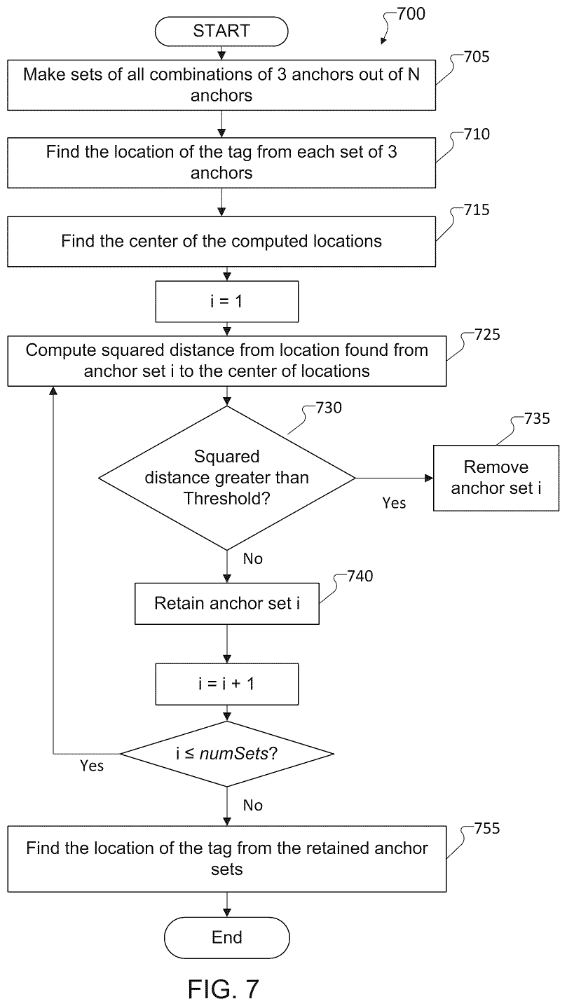

Note that if the quantity of anchors is more than three (i.e., minimum quantity of anchors), there will be numSets of measurements that allows to remove erroneous measurements and generate more accurate and stable positioning. For instance, if five anchors are used for positioning, there will be ten sets of three anchors. As such, ten locations for the tag will be found which allows to remove erroneous values via some filtering. Several such embodiments are described with respect to FIGS. 7-11.

FIG. 7 illustrates an example method of tag location determination 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments of tag location determination could be used without departing from the scope of this disclosure.

As illustrated in FIG. 7, the method 700 begins at step 705. At step 705, sets are made for all combinations of 3 anchors out of N anchors.

At step 710, for each set of three anchors the location of the tag is found (Xₜᵢ, Yₜᵢ, Zₜᵢ), i=1, . . . , numSets. Define A={1, . . . , numSets}.

At step 715, the center of the locations is found. In one embodiment, the center of the locations is found as follows:

$${X}_{c} = \frac{1}{numSets} {\sum }_{i = 1}^{numSets} {X}_{t i}$$

$${Y}_{c} = \frac{1}{numSets} {\sum }_{i = 1}^{numSets} {Y}_{t i}$$

$${Z}_{c} = \frac{1}{numSets} {\sum }_{i = 1}^{numSets} {Z}_{t i}$$

At step 725, the squared distance from each computed location to the center of locations is determined. In one embodiment, the squared distance from each computed location to the center of locations is determined as follows:

Lᵢ²=(X_{c}−Xₜᵢ)²+(Y_{c}−Yₜᵢ)²+(Z_{c}−Zₜᵢ)²

At step 730, a determination is made whether the squared distance computed in step 725 is greater than a threshold distance.

At step 735, any anchor set whose squared distance is greater than a pre-defined threshold distance is removed. In one example if Lᵢ²>ThL, remove the corresponding anchor set; A=A\{i}.

At step 735, any anchor set whose squared distance is less than a pre-defined threshold distance is retained.

At step 755, the location of the tag is determined from the retained anchor sets. In one embodiment, the location may be determined as follows:

$${X}_{t} = \frac{1}{\vert A \vert} {\sum }_{i ∈ A} {X}_{ti}$$

$${Y}_{t} = \frac{1}{\vert A \vert} {\sum }_{i ∈ A} {Y}_{ti}$$

$${Z}_{t} = \frac{1}{\vert A \vert} {\sum }_{i ∈ A} {Z}_{ti}$$

where |A| denotes the number of elements of A (after removing the erroneous anchor sets).

Although FIG. 7 illustrates one example method of tag location determination 700, various changes may be made to FIG. 7. For example, while shown as a series of steps, various steps in FIG. 7 could overlap, occur in parallel, occur in a different order, or occur any number of times.

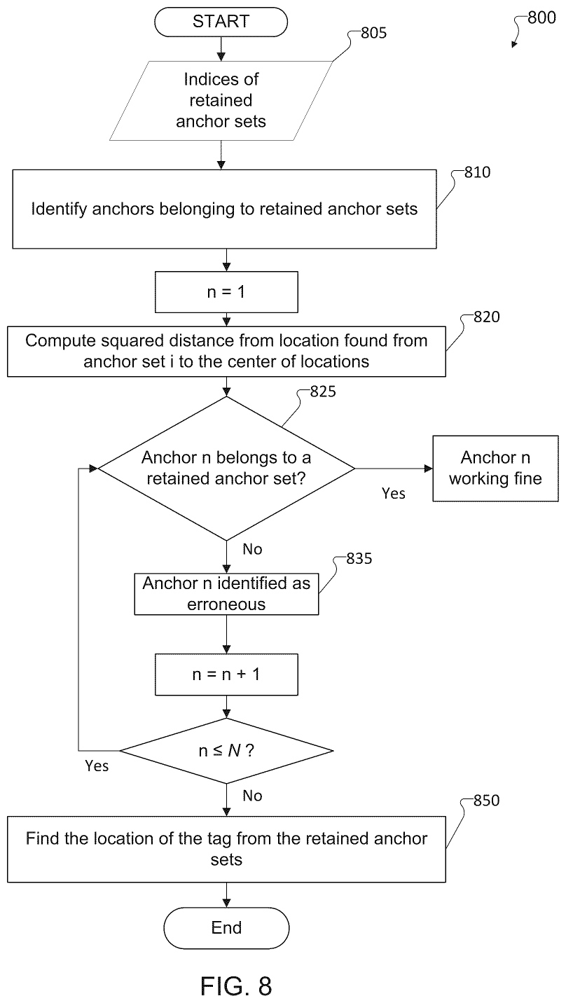

In the above example, the erroneous values are dropped from the positioning of the tag. Additionally, the anchors that produce erroneous distance measurement may be identified as illustrated in FIG. 8.

FIG. 8 illustrates an example method of tag location determination 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of tag location determination could be used without departing from the scope of this disclosure.

As illustrated in FIG. 8, the method 800 begins at step 805. At step 805, a final set of anchors is input, such as the final set A as described regarding FIG. 7, which contains the indices of the “acceptable” anchor sets.

At step 810, all anchors belonging to the “acceptable” anchor sets are identified.

At step 820, the squared distance from each computed location to the center of locations is determined, similar as described regarding FIG. 7.

At step 825, a determination is made whether anchor n belongs to a retained anchor set.

At step 835, any anchor which does not belong to an acceptable anchor set will be identified as an erroneous anchor (i.e., either occluded by objects or defective).

At step 850, the location of the tag is determined from the retained anchor sets, similar as described regarding FIG. 7.

Although FIG. 8 illustrates one example method of tag location determination 700, various changes may be made to FIG. 8. For example, while shown as a series of steps, various steps in FIG. 8 could overlap, occur in parallel, occur in a different order, or occur any number of times.

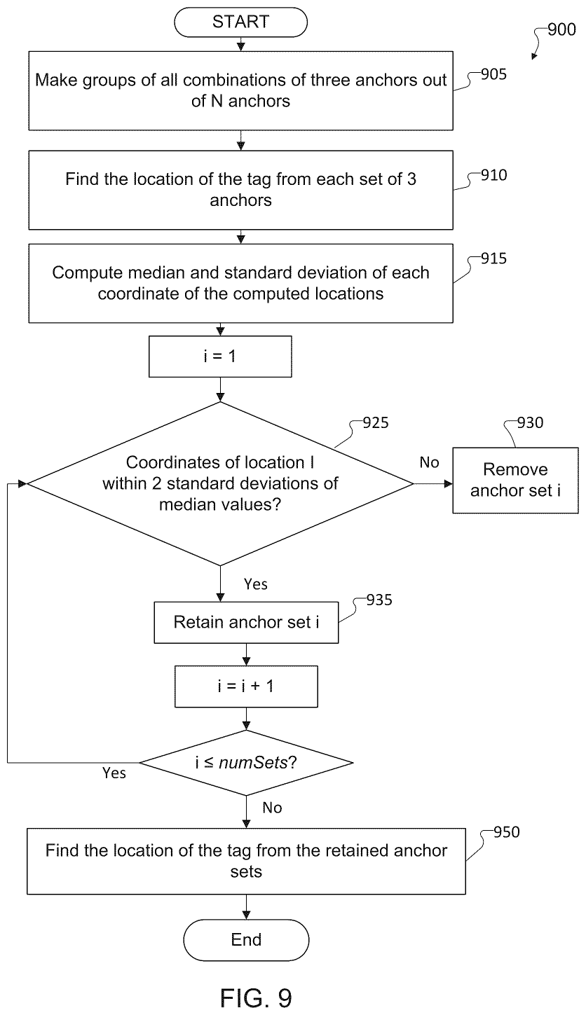

FIG. 9 illustrates an example method of tag location determination 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of tag location determination could be used without departing from the scope of this disclosure.

In this method, similar to the methods of FIGS. 7 and 8, groups of three anchors (out of N anchors) are used to find the location of a tag. Then the erroneous measurements are removed prior to finding the location of the tag.

As illustrated in FIG. 9, the method 900 begins at step 905. At step 905, sets are made for all combinations of 3 anchors out of N anchors.

At step 910, for each set of three anchors the location of the tag is found, similar as described regarding FIG. 7.

At step 915, the median and standard deviation for each coordinate of the anchor locations found in step 910. In one embodiment, the median and standard deviation of the coordinates are computed as follows:

ξ_{X}=median({Xₜᵢ}),σ_{X}=std({Xₜᵢ}),

ξ_{Y}=median({Yₜᵢ}),σ_{Y}=std({Yₜᵢ}),

ξ_{Z}=median({Zₜᵢ}),σ_{Z}=std({Zₜᵢ}),

At step 925, for each anchor set, a determination is made if all coordinates are within two standard deviations of the median value.

At step 925, if the coordinates are not within a pre-defined threshold from the median value, the corresponding anchor set is removed. In one example If |Xₜᵢ−ξ_{X}|>2σ_{X}, or |Yₜᵢ−ξ_{Y}|>2σ_{Y}, or |Zₜᵢ−ξ_{Z}|>2σ_{Z}, remove the corresponding anchor set; A=A\{i}.

At step 925, the location of the tag is determined from the from the remaining anchor sets. In one embodiment, the location of the tag is determined as follows:

$${X}_{t} = \frac{1}{\vert A \vert} {\sum }_{i ∈ A} {X}_{ti}$$

$${Y}_{t} = \frac{1}{\vert A \vert} {\sum }_{i ∈ A} {Y}_{ti}$$

$${Z}_{t} = \frac{1}{\vert A \vert} {\sum }_{i ∈ A} {Z}_{ti}$$

where |A| denotes the number of elements of A (after removing the erroneous anchor sets).

In one embodiment, erroneous anchors may be identified similar as described regarding FIG. 8.

Although FIG. 8 illustrates one example method of tag location determination 700, various changes may be made to FIG. 8. For example, while shown as a series of steps, various steps in FIG. 8 could overlap, occur in parallel, occur in a different order, or occur any number of times.

In the methods described regarding FIGS. 7-9, the selection of anchors may be performed as follows:
(a) Dynamically select a new optimal anchor set every time a position is requested/computed.
(b) Selection of anchors may include an indoor/outdoor environment.
(c) Selection of anchors may include the process/method of transfer and selection of anchors from an outdoor mobile environment (car UWB+GPS tag) to an indoor environment.
(d) Selection of anchors may include a mobile user (UWB tag in key fob).
(e) Selection of anchors may be retained (a) as well as the last absolute location and if within a pre-determined threshold, reuse the same set of anchors to compute solution.
(f) Anchors may be configured in a 2D or 3D system.

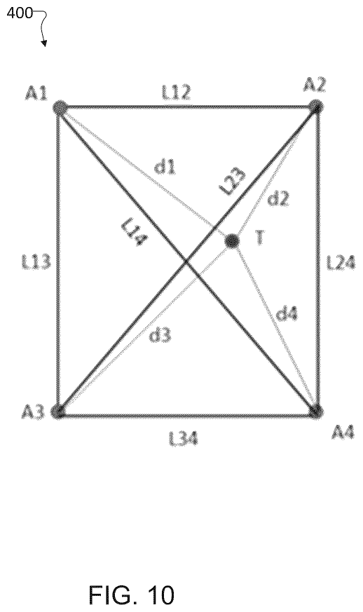

Triangle inequality may be used to identify non line of sight (NLOS) anchors. In a triangle, the size of each side must be smaller than the sum of the sizes of the other two sides. The triangle inequality might not be hold for an anchor in the NLOS position as the distance between an NLOS anchor and the tag is larger than the length of the LOS path. In order to check for this inequality, all the triangles with two vertices at two anchors and the third vertex at the tag may be identified. Then, the triangle inequality may be checked for the two sides of each triangle where these sides will be the sides between the tag and the two anchors. If the inequality triangle does not hold for any side for any side, the anchor in that side must be in an NLOS position. This case may arise when the measured distanced between an anchor and the tag is large due to a NLOS path between the tag and that anchor. Such an example is illustrated in FIG. 10.

FIG. 10 illustrates a special arrangement of example system 400 in which wireless positioning anchor locations can be determined for service areas of an indoor location based service according to embodiments of the present disclosure.

As illustrated in FIG. 10, system 400 includes 4 anchors A1-A4. In the example of FIG. 10, the following inequality must hold in each triangle forming from two anchors and the tag:

dᵢ<dⱼ+Lᵢⱼ

dⱼ<dᵢ+Lᵢⱼ

where i, j=1, . . . ,4 (in FIG. 10, there are 6*2=12 inequalities). If any of these inequalities does not hold for any anchor, that anchor is in a NLOS position.

For N anchors, the number of triangles will be

$$\frac{N !}{2 ! ( N - 2 ) !} ,$$

and the number of triangle inequalities will be

$$\frac{N !}{( N - 2 ) !} .$$

If N is much greater than 2, the number of the inequalities will be approximately N². For a large quantity of anchors, statistical analysis of the distance measurements may be more efficient from the computation perspective.

Although FIG. 10 illustrates one example of a wireless positioning system, various changes may be made to FIG. 10. For example, the locations of the of anchors may differ, the target object may be a placed at a different location, etc.

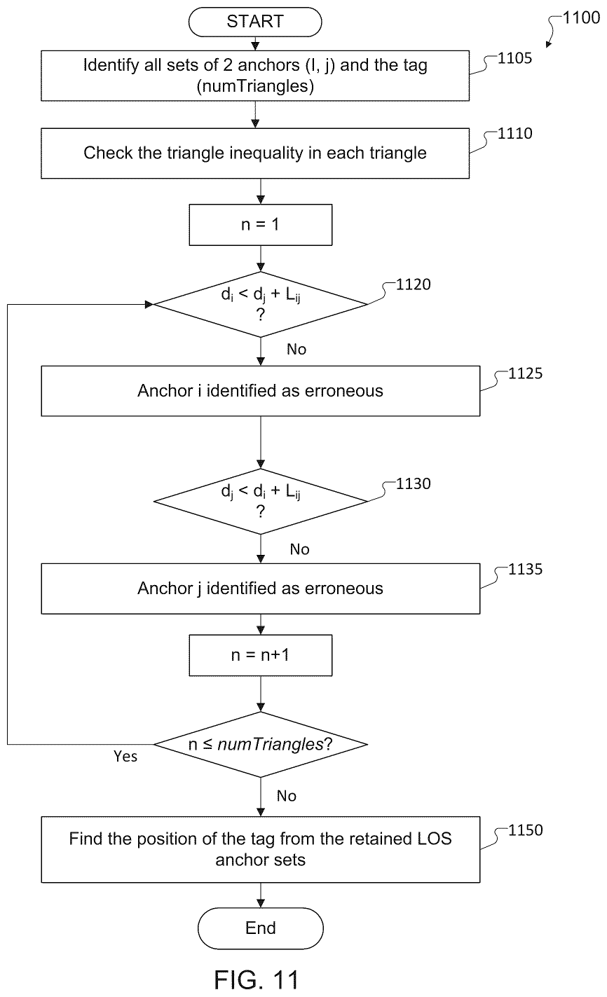

Determining the location of a tag while identifying NLOS anchors as described regarding FIG. 10 may be performed similar as described regarding FIG. 11.

FIG. 11 illustrates an example method of tag location determination 1100 according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of tag location determination could be used without departing from the scope of this disclosure.

As illustrated in FIG. 11, the method 1100 begins at step 1105. At step 1105, all sets of 2 anchors and the tag are identified.

At step 1110, the triangle inequality is determined for each triangle identified in step 1105, similar as described regarding FIG. 10.

At step 1120, for each triangle a determination is made if dᵢ<dⱼ+Lᵢⱼ.

At step 1125, if the determination made in step 1120 is negative, then anchor i is identified as erroneous.

At step 1130, for each triangle a determination is made if dⱼ<dᵢ+Lᵢⱼ.

At step 1135, if the determination made in step 1120 is negative, then anchor j is identified as erroneous.

At step 1150, the position of the tag is determined from the retained LOS anchor sets. The position may be determined as previously described.

Although FIG. 11 illustrates one example method of tag location determination 1100, various changes may be made to FIG. 11. For example, while shown as a series of steps, various steps in FIG. 11 could overlap, occur in parallel, occur in a different order, or occur any number of times.

Variants of Bluetooth® low energy (BLE) localization methods (e.g., BLE received signal strength indicator (RSSI), BLE Time of Flight, BLE Phase of Flight, BLE Angle of Arrival, etc.) and UWB technologies may be combined to improve accuracy of positioning. BLE, while using very low energy, may detect an approximate location of a target object. BLE approximate positioning may be combined with UWB positioning to add constraints on the distance measurements by UWB anchors and identify erroneous measurements. This may lead to more accurate UWB positioning. In one embodiment of combined use of BLE and UWB, in order to save on energy, BLE may be used to detect the presence of a target object in the scene and once an object is detected, UWB anchors are activated for robust and accurate UWB positioning.

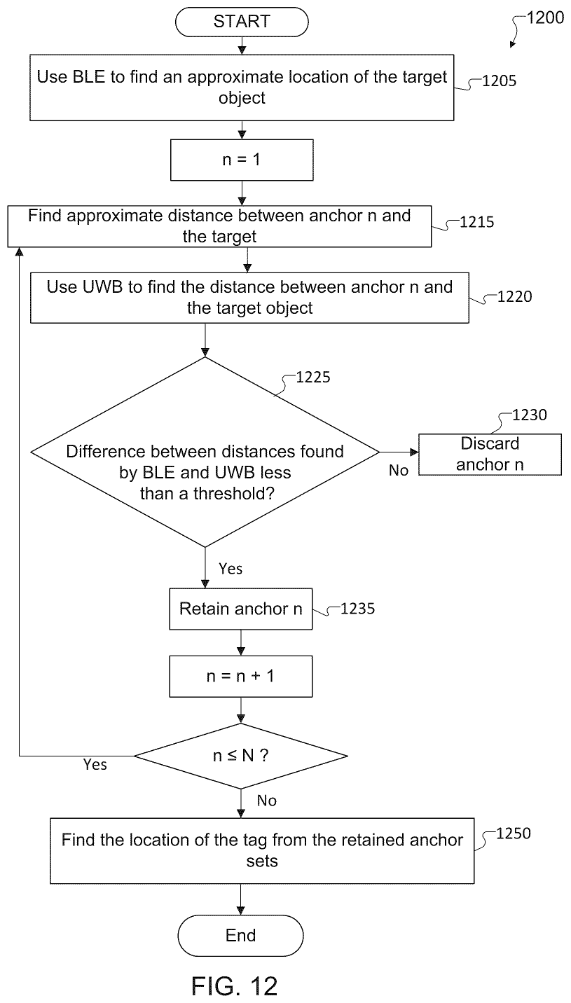

FIG. 12 illustrates an example method of tag location determination 1200 utilizing both BLE and UWB according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of tag location determination could be used without departing from the scope of this disclosure.

As illustrated in FIG. 12, the method 1200 begins at step 1205. At step 1205, BLE is used to find an approximate location of the target object.

At step 1215, for each anchor an approximate distance between the target and the anchor is determined.

At step 1220, for each anchor UWB is used to determine a distance between the target the anchor.

At step 1225, a difference is determined between the distances found by BLE and UWB.

At step 1230, if the difference determined in step 1225 is above a threshold, the anchor is discarded (identified as erroneous).

At step 1235, if the difference determined in step 1225 is below a threshold, the anchor is retained.

At step 1250, the location of the tag is determined from the retained anchor sets. The location may be determined as previously described.

Although FIG. 12 illustrates one example method of tag location determination 1200, various changes may be made to FIG. 12. For example, while shown as a series of steps, various steps in FIG. 12 could overlap, occur in parallel, occur in a different order, or occur any number of times.

WiFi round trip time (WiFi-RTT) and UWB technologies may be combined to improve accuracy of positioning. WiFi-RTT may determine the location with a precision of around 1 meter. Similar as described regarding FIG. 12, WiFi-RTT approximate positioning may be used as a constraint on the distance measurements by UWB anchors and identify erroneous measurements. This may lead to robust and accurate UWB.

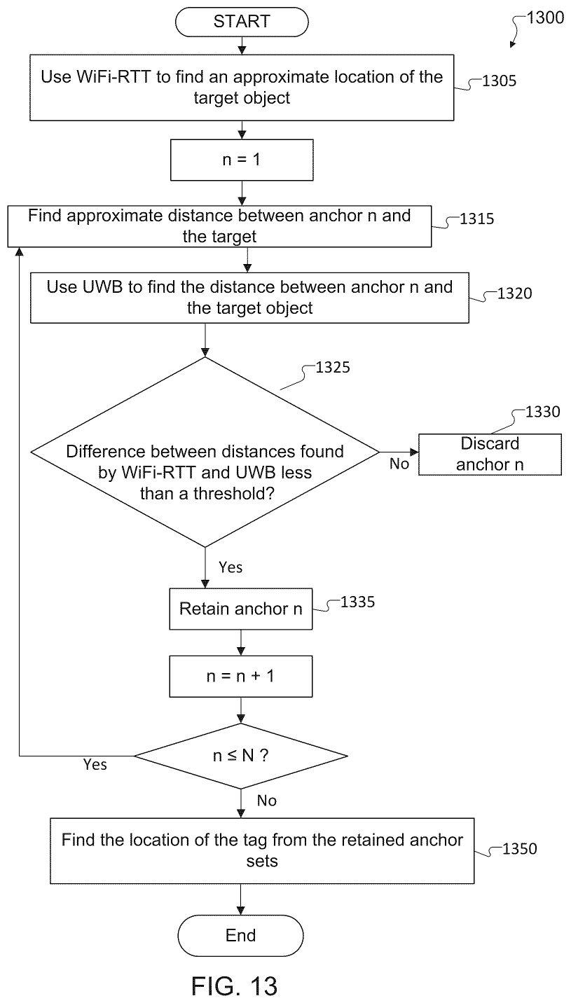

FIG. 13 illustrates an example method of tag location determination 1300 utilizing both WiFi-RTT and UWB according to embodiments of the present disclosure. An embodiment of the method illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of tag location determination could be used without departing from the scope of this disclosure.

As illustrated in FIG. 13, the method 1300 begins at step 1305. At step 1305, WiFi-RTT is used to find an approximate location of the target object.

At step 1315, for each anchor an approximate distance between the target and the anchor is determined.

At step 1320, for each anchor UWB is used to determine a distance between the target the anchor.

At step 1325, a difference is determined between the distances found by WiFi-RTT and UWB.

At step 1330, if the difference determined in step 1325 is above a threshold, the anchor is discarded (identified as erroneous).

At step 1335, if the difference determined in step 1325 is below a threshold, the anchor is retained.

At step 1350, the location of the tag is determined from the retained anchor sets. The location may be determined as previously described.

Although FIG. 13 illustrates one example method of tag location determination 1300, various changes may be made to FIG. 13. For example, while shown as a series of steps, various steps in FIG. 13 could overlap, occur in parallel, occur in a different order, or occur any number of times.

Information obtained from images taken from a scene and UWB anchors may be combined to generate more accurate and robust positioning. In cluttered environments, UWB anchors might be occluded by objects and there may not be enough anchors in the line-of-sight of the tag. For this case, if images of the target object are taken from multiple cameras installed in the known locations in the scene, it may be possible to find the location of the target object through photogrammetry. The locations found from UWB positioning and from photogrammetry may be analyzed (and filtered out) to retain reliable locations and perform robust and accurate positioning.

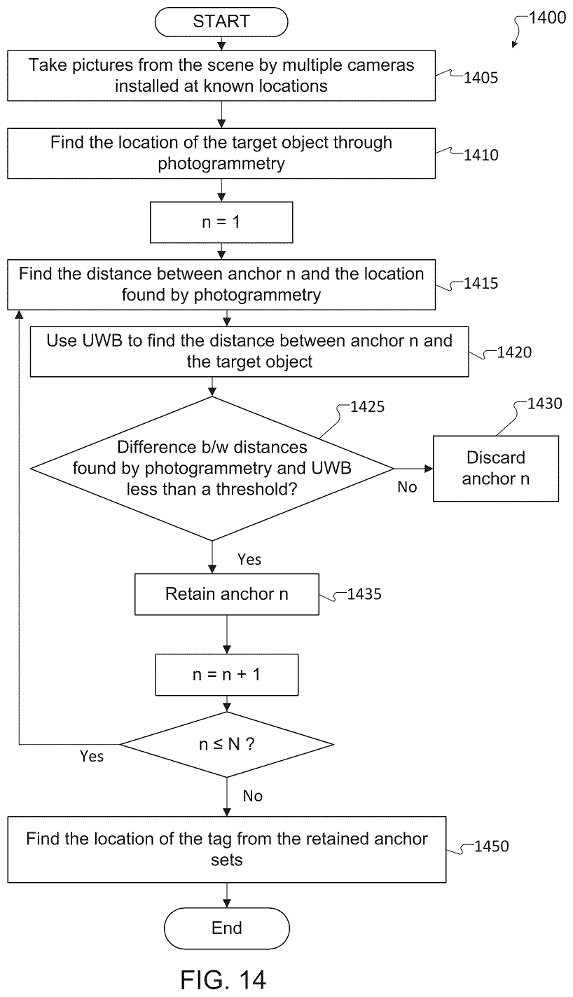

FIG. 14 illustrates an example method of tag location determination 1400 utilizing both photogrammetry and UWB according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of tag location determination could be used without departing from the scope of this disclosure.

As illustrated in FIG. 14, the method 1400 begins at step 1405. At step 1405, images from the scene are taken by multiple cameras installed at known locations.

At step 1410, the location of the target object is found using photogrammetry.

At step 1415, for each anchor an approximate distance between the target and the anchor is determined.

At step 1420, for each anchor UWB is used to determine a distance between the target the anchor.

At step 1425, a difference is determined between the distances found by photogrammetry and UWB.

At step 1430, if the difference determined in step 1425 is above a threshold, the anchor is discarded (identified as erroneous).

At step 1435, if the difference determined in step 1425 is below a threshold, the anchor is retained.

At step 1450, the location of the tag is determined from the retained anchor sets. The location may be determined as previously described.

Although FIG. 14 illustrates one example method of tag location determination 1400, various changes may be made to FIG. 14. For example, while shown as a series of steps, various steps in FIG. 14 could overlap, occur in parallel, occur in a different order, or occur any number of times.

The approximate location of a target object may be found by some applications such as Quick app. Similar to other embodiments, the approximate location of the tag may be used to identify erroneous UWB measurements.

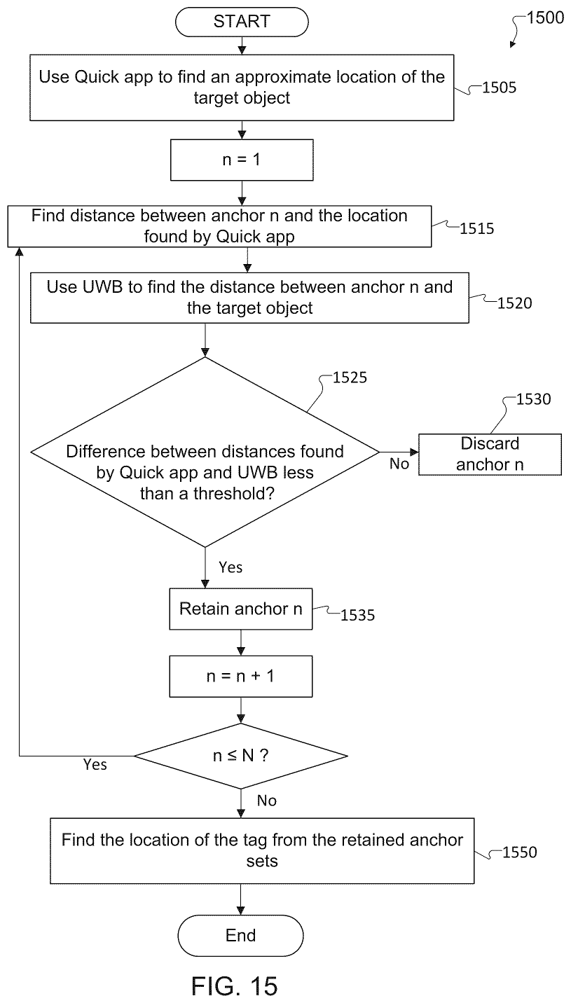

FIG. 15 illustrates an example method of tag location determination 1500 utilizing both an application and UWB according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of tag location determination could be used without departing from the scope of this disclosure. For example, while FIG. 15 is illustrated as utilizing Quick app, any application may be used in lieu of or in addition to Quick app.

As illustrated in FIG. 15, the method 1500 begins at step 1505. At step 1505, an application is used to find an approximate location of the target object.

At step 1515, for each anchor an approximate distance between the target and the anchor is determined.

At step 1520, for each anchor UWB is used to determine a distance between the target the anchor.

At step 1525, a difference is determined between the distances found by the application and UWB.

At step 1530, if the difference determined in step 1525 is above a threshold, the anchor is discarded (identified as erroneous).

At step 1535, if the difference determined in step 1525 is below a threshold, the anchor is retained.

At step 1550, the location of the tag is determined from the retained anchor sets. The location may be determined as previously described.

Although FIG. 15 illustrates one example method of tag location determination 1500, various changes may be made to FIG. 15. For example, while shown as a series of steps, various steps in FIG. 15 could overlap, occur in parallel, occur in a different order, or occur any number of times.

The outline of a service area (for example service area 302 of FIG. 3) may be obtained using manual entry, an application, a robotic vacuum cleaner, photogrammetry, radar, lidar, ultrasonic measurement, or any other known method. This outline may be used to verify the distances measured by wireless positioning anchors. Any measured distance outside of the service area boundaries may be considered erroneous and hence dropped from UWB positioning process.

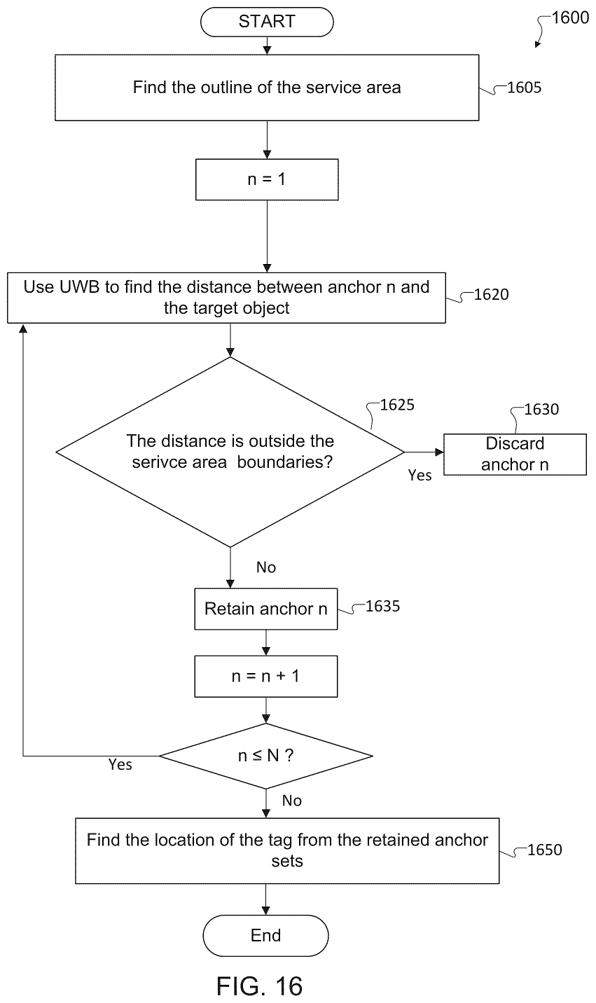

FIG. 16 illustrates an example method of tag location determination 1600 utilizing both a service area boundary and UWB according to embodiments of the present disclosure. An embodiment of the method illustrated in FIG. 16 is for illustration only. One or more of the components illustrated in FIG. 16 may be implemented in specialized circuitry configured to perform the noted functions or one or more of the components may be implemented by one or more processors executing instructions to perform the noted functions. Other embodiments of tag location determination could be used without departing from the scope of this disclosure.

As illustrated in FIG. 16, the method 1600 begins at step 1605. At step 1605, the outline of the service area is determined.

At step 1620, for each anchor UWB is used to determine a distance between the target the anchor.

At step 1625, it is determined if the distance measured in step 1620 is outside the service area boundaries.

At step 1630, if the difference determined in step 1625 if the distance measured in step 1620 is outside the service area boundaries, the anchor is discarded (identified as erroneous).

At step 1635, if the distance measured in step 1620 is outside the service area boundaries, the anchor is retained.

At step 1650, the location of the tag is determined from the retained anchor sets. The location may be determined as previously described.

Although FIG. 16 illustrates one example method of tag location determination 1600, various changes may be made to FIG. 16. For example, while shown as a series of steps, various steps in FIG. 16 could overlap, occur in parallel, occur in a different order, or occur any number of times.

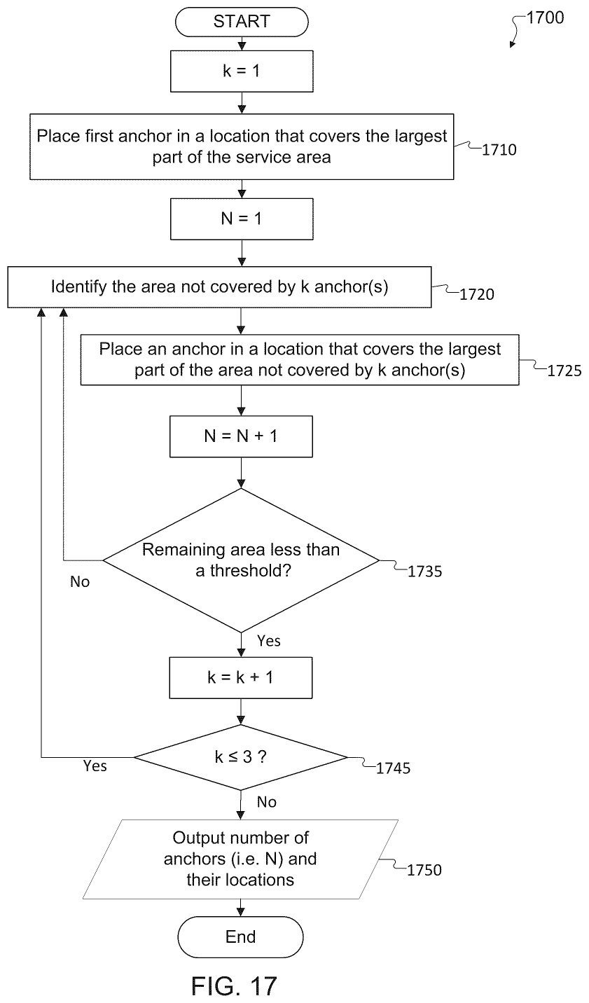

As previously described, at least three localization anchors are needed to localize a target object in the 3D space. However, in cluttered indoor environments some objects might block the direct view between a tag and an anchor. This may significantly affect the accuracy of wireless positioning. Optimal placement of localization anchors in indoor environments is desirable while performing accurate positioning with minimum quantity of anchors. Optimal placement environments for indoor anchors may be achieved using a greedy algorithm based on a requirement that each point in a service area be in the line-of-sight of at least three anchors such as described regarding FIG. 17.

FIG. 17 illustrates an example method of anchor placement 1700 utilizing according to embodiments of the present disclosure. An embodiment of the method illustrated in FIG. 17 is for illustration only. One or more of the components illustrated in FIG. 17 may be implemented in specialized circuitry configured to perform the noted functions or one or more of the components may be implemented by one or more processors executing instructions to perform the noted functions. Other embodiments of anchor placement could be used without departing from the scope of this disclosure.

As illustrated in FIG. 17, the method 1700 begins at step 1710. At step 1710, a first anchor is placed in a location that covers the largest part of the service area (i.e., in direct view of the anchor). The area covered by the first anchor is marked.

At step 1720, the portion of the service area remaining uncovered by any anchors is determined.

At step 1725, an additional anchor is placed in a location that covers the largest part of the remaining uncovered portion of the service area.

At step 1735, a determination is made whether the portion of the service area left uncovered by the previously placed anchors is below a threshold. If the threshold is exceeded, steps 1720-1735 are repeated.

At step 1745, a determination is made whether at least three anchors have been placed. If three anchors have not been places, steps 1720-1745 are repeated.

At step 1750, the total quantity of anchors and their respective locations are output.

The method described regarding FIG. 17 may provide the locations of a minimum quantity of anchors that will cover the service area other than very small areas near corners or irregular boundaries. Additionally, a large portion of the service area may be covered by more than three anchors which allows performance of robust wireless positioning as previously described.

Although FIG. 17 illustrates one example method of anchor placement 1700, various changes may be made to FIG. 17. For example, while shown as a series of steps, various steps in FIG. 17 could overlap, occur in parallel, occur in a different order, or occur any number of times.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. An apparatus comprising:
a transceiver configured to receive, from each of a plurality of anchors, a signal based on which a tag distance corresponding to a distance of a tag from the respective anchor is identified; and
a processor operably coupled to the transceiver, configured to:
determine a plurality of anchor sets from the plurality of anchors;
for each of the anchor sets, determine, based on the tag distances corresponding to anchors in the anchor set, a preliminary tag location corresponding to the respective anchor set; and
determine a final tag location based on the preliminary tag locations.

2. The apparatus of claim 1, wherein:
the final tag location is determined based on a statistical analysis of the preliminary tag locations,
the plurality of anchors includes at least four anchors, and
each of the plurality of anchor sets includes three anchors.

3. The apparatus of claim 1, wherein to determine the final tag location, the processor is further configured to:
determine a center tag location based on the preliminary tag locations;
for each of the anchor sets:
determine a squared tag distance associated with the respective anchor set;
determine if the squared tag distance is greater than a threshold distance; and
if the squared tag distance is greater than the threshold distance, remove the respective anchor set from the plurality of anchor sets and generate a retained anchor set group; and
determine the final tag location based on the preliminary tag locations corresponding to the retained anchor set group.

4. The apparatus of claim 3, wherein the processor is further configured to, for each of the plurality of anchors:
determine whether the respective anchor belongs to a retained anchor set; and
if the respective anchor does not belong to a retained anchor set, identify the respective anchor as erroneous.

5. The apparatus of claim 1, wherein to determine the final tag location, the processor is further configured to:
determine an X coordinate, a Y coordinate, and a Z coordinate for each preliminary tag location, creating an X coordinate set, a Y coordinate set, and a Z coordinate set;
determine a median and standard deviation for each of the X coordinate set, the Y coordinate set, and the Z coordinate set;
for each of the anchor sets:
determine whether the X coordinate, Y coordinate, and Z coordinate for the preliminary tag location associated with the anchor set are within two standard deviations of the median value of the respective coordinate set; and
if any of the X coordinate, the Y coordinate, or the Z coordinate are more than two standard deviations from the median value of the respective coordinate set, remove the respective anchor set from the plurality of anchor sets and generate a retained anchor set group; and
determine the final tag location based on the preliminary tag locations corresponding to the retained anchor set group.

6. The apparatus of claim 1, wherein to determine the plurality of anchor sets, the processor is further configured to:
determine a 2-anchor set from the plurality of anchors, each 2-anchor set comprising a first anchor and a second anchor;
identify a triangle for each 2-anchor set, each triangle comprising vertices at the first anchor, the second anchor, and the tag;
for each of the identified triangles:
determine whether the tag distance associated with the first anchor is less than a sum of the tag distance associated with the second anchor and a distance between the first anchor and the second anchor;
if the tag distance associated with the first anchor is greater than the sum of the tag distance associated with the second anchor and the distance between the first anchor and the second anchor, identify the first anchor as an erroneous anchor and generate a retained anchor group;
determine whether the tag distance associated with the second anchor is less than the sum of the tag distance associated with the first anchor and the distance between the first anchor and the second anchor;
if the tag distance associated with the second anchor is greater than the sum of the tag distance associated with the first anchor and the distance between the first anchor and the second anchor, identify the second anchor as an erroneous anchor; and
if the first or second anchor are identified as erroneous, remove the anchors identified as erroneous from the plurality of anchors and generate a retained plurality of anchors; and
wherein the plurality of anchor sets is determined based on the retained plurality of anchors.

7. A method comprising:
receiving, from each of a plurality of anchors, a signal based on which a tag distance corresponding to a distance of a tag from the respective anchor is identified;
determining a plurality of anchor sets from the plurality of anchors;
for each of the anchor sets, determining, based on the tag distances corresponding to anchors in the anchor set, a preliminary tag location corresponding to the respective anchor set; and
determining a final tag location based on the preliminary tag locations.

8. The method of claim 7, wherein:
the final tag location is determined based on a statistical analysis of the preliminary tag locations,
the plurality of anchors includes at least four anchors, and
each of the plurality of anchor sets includes three anchors.

9. The method of claim 7, wherein determining the final tag location comprises:
determining a center tag location based on the preliminary tag locations;
for each of the anchor sets:
determining a squared tag distance associated with the respective anchor set;
determining if the squared tag distance is greater than a threshold distance; and
if the squared tag distance is greater than the threshold distance, removing the respective anchor set from the plurality of anchor sets and generating a retained anchor set group; and
determining the final tag location based on the preliminary tag locations corresponding to the retained anchor set group.

10. The method of claim 9, further comprising:
for each of the plurality of anchors:
determining whether the respective anchor belongs to a retained anchor set; and
if the respective anchor does not belong to a retained anchor set, identifying the respective anchor as erroneous.

11. The method of claim 7, wherein determining the final tag location comprises:
determining an X coordinate, a Y coordinate, and a Z coordinate for each preliminary tag location, creating an X coordinate set, a Y coordinate set, and a Z coordinate set;
determining a median and standard deviation for each of the X coordinate set, the Y coordinate set, and the Z coordinate set;
for each of the anchor sets:
determining whether the X coordinate, Y coordinate, and Z coordinate for the preliminary tag location associated with the anchor set are within two standard deviations of the median value of the respective coordinate set; and
if any of the X coordinate, the Y coordinate, or the Z coordinate are more than two standard deviations from the median value of the respective coordinate set, removing the respective anchor set from the plurality of anchor sets and generating a retained anchor set group; and
determining the final tag location based on the preliminary tag locations corresponding to the retained anchor set group.

12. The method of claim 7, wherein determining the plurality of anchor sets comprises:
determining a 2-anchor set from the plurality of anchors, each 2-anchor set comprising a first anchor and a second anchor;
identifying a triangle for each 2-anchor set, each triangle comprising vertices at the first anchor, the second anchor, and the tag;
for each of the identified triangles:
determining whether the tag distance associated with the first anchor is less than a sum of the tag distance associated with the second anchor and a distance between the first anchor and the second anchor;
if the tag distance associated with the first anchor is greater than the sum of the tag distance associated with the second anchor and the distance between the first anchor and the second anchor, identifying the first anchor as an erroneous anchor and generating a retained anchor group;
determining whether the tag distance associated with the second anchor is less than the sum of the tag distance associated with the first anchor and the distance between the first anchor and the second anchor;
if the tag distance associated with the second anchor is greater than the sum of the tag distance associated with the first anchor and the distance between the first anchor and the second anchor, identifying the second anchor as an erroneous anchor; and
if the first or second anchor are identified as erroneous, removing the anchors identified as erroneous from the plurality of anchors and generating a retained plurality of anchors; and
wherein the plurality of anchor sets is determined based on the retained plurality of anchors.

13. A non-transitory computer readable medium embodying a computer program, the computer program comprising program code that, when executed by a processor of a device, causes the device to:
receive, from each of a plurality of anchors, a signal based on which a tag distance corresponding to a distance of a tag from the respective anchor is identified;
determine a plurality of anchor sets from the plurality of anchors;
for each of the anchor sets, determine, based on the tag distances corresponding to anchors in the anchor set, a preliminary tag location corresponding to the respective anchor set; and
determine a final tag location based on the preliminary tag locations.

14. The non-transitory computer readable medium of claim 13, wherein:
the final tag location is determined based on a statistical analysis of the preliminary tag locations,
the plurality of anchors includes at least four anchors, and
each of the plurality of anchor sets includes three anchors.

15. The non-transitory computer readable medium of claim 13, wherein to determine the final tag location, the computer program comprises program code that, when executed by the processor, causes the device to:
determine a center tag location based on the preliminary tag locations;
for each of the anchor sets:
determine a squared tag distance associated with the respective anchor set;
determine if the squared tag distance is greater than a threshold distance; and
if the squared tag distance is greater than the threshold distance, remove the respective anchor set from the plurality of anchor sets and generate a retained anchor set group; and
determine the final tag location based on the preliminary tag locations corresponding to the retained anchor set group.

16. The non-transitory computer readable medium of claim 15, wherein the computer program further comprises program code that, when executed by the processor, causes the device to:
for each of the plurality of anchors:
determine whether the respective anchor belongs to a retained anchor set; and
if the respective anchor does not belong to a retained anchor set, identify the respective anchor as erroneous.

17. The non-transitory computer readable medium of claim 13, wherein to determine the final tag location, the computer program further comprises program code that, when executed by the processor, causes the device to:
determine an X coordinate, a Y coordinate, and a Z coordinate for each preliminary tag location, creating an X coordinate set, a Y coordinate set, and a Z coordinate set;
determine a median and standard deviation for each of the X coordinate set, the Y coordinate set, and the Z coordinate set;
for each of the anchor sets:
determine whether the X coordinate, Y coordinate, and Z coordinate for the preliminary tag location associated with the anchor set are within two standard deviations of the median value of the respective coordinate set; and
if any of the X coordinate, the Y coordinate, or the Z coordinate are more than two standard deviations from the median value of the respective coordinate set, remove the respective anchor set from the plurality of anchor sets and generate a retained anchor set group; and
determine the final tag location based on the preliminary tag locations corresponding to the retained anchor set group.

18. The non-transitory computer readable medium of claim 13, wherein to determine the plurality of anchor sets, the computer program comprises program code that, when executed by the processor, causes the device to:
determine a 2-anchor set from the plurality of anchors, each 2-anchor set comprising a first anchor and a second anchor;
identify a triangle for each 2-anchor set, each triangle comprising vertices at the first anchor, the second anchor, and the tag;
for each of the identified triangles:
determine whether the tag distance associated with the first anchor is less than a sum of the tag distance associated with the second anchor and a distance between the first anchor and the second anchor;
if the tag distance associated with the first anchor is greater than the sum of the tag distance associated with the second anchor and the distance between the first anchor and the second anchor, identify the first anchor as an erroneous anchor and generating a retained anchor group;
determine whether the tag distance associated with the second anchor is less than the sum of the tag distance associated with the first anchor and the distance between the first anchor and the second anchor;
if the tag distance associated with the second anchor is greater than the sum of the tag distance associated with the first anchor and the distance between the first anchor and the second anchor, identify the second anchor as an erroneous anchor; and
if the first or second anchor are identified as erroneous, remove the anchors identified as erroneous from the plurality of anchors and generating a retained plurality of anchors; and
wherein the plurality of anchor sets is determined based on the retained plurality of anchors.

19. A method for anchor placement comprising:
determining a first anchor position for an anchor location that covers a largest portion of a workspace;
identifying a remaining portion of the workspace is uncovered by the first anchor position;
determining an additional anchor position for an additional anchor location that covers a largest part of the remaining portion of the workspace; and
determining whether a portion of the remaining portion of the workspace uncovered by the additional anchor position is below a threshold.

20. The method of claim 19, further comprising:
if the portion of the remaining portion of the workspace uncovered by the additional anchor position is above the threshold, determining a further anchor position for a further anchor location that covers a remaining largest part of the remaining portion of the workspace;
if the portion of the remaining portion of the workspace uncovered by the additional anchor position is below the threshold, determining whether a portion of the workspace covered by the anchors is covered by at least three anchors;
if the portion of the of the workspace covered by the anchors is covered by less than three anchors, identifying the portion of the workspace covered by less than three anchors and determining a supplemental anchor position for a supplemental anchor location that covers the portion of the workspace covered by less than three anchors; and
if the portion of the workspace covered by the anchors is covered by at least three anchors, determining a quantity of anchors and anchor positions.
